(19) United States
(12) Patent Application Publication
(10) Pub. No.: US 2024/0230219 A9
(43) Pub. Date: Jul. 11, 2024

(54) NH3 STORAGE AND TRANSPORTATION SYSTEM AND METHOD

(71) Applicant: TOROMONT INDUSTRIES LTD., Concord (CA)

(72) Inventor: Bashar NASER, St. George (CA)

(21) Appl. No.: 18/493,989

(22) Filed: Oct. 25, 2023

Related U.S. Application Data
(60) Provisional application No. 63/380,819, filed on Oct. 25, 2022.

(51) Int. Cl. F25J 1/00

(52) U.S. Cl. CPC F25J 1/0022

(57) ABSTRACT

A liquefaction heat pump system may have: a storage vessel configured to receive a liquified fuel from a piping grid network. A heat pump circuit may include sequentially at least a compression stage configured to compress the fuel, a heat pump stage configured to receive the compressed fuel from the compression stage, and to heat a coolant by removing heat from the compressed fuel by at least one heat exchanger. A pumping arrangement is configured to pump fuel from the storage vessel and/or from the heat pump circuit back to the piping grid network. A controller unit is configured for operating the liquefaction heat pump system such that fuel is liquefied and a coolant is heated by the heat pump circuit.

### CROSS-REFERENCE TO RELATED APPLICATION

The present application claims the benefit of U.S. Patent Application No. 63/380,819, filed on Oct. 25, 2022 and incorporated herein by reference.

### FIELD OF THE APPLICATION

The present application relates to pipeline transportation for liquefied fuel or gas, such as ammonia.

### BACKGROUND OF THE ART

Energy consumption remains a global issue for numerous reasons and factors: geopolitics, environment, scarcity and demand, among others. Moreover, there is no sign of any significant decline in energy consumption. Accordingly, energy supply systems must be as efficient as ever.

There currently exists different models to meet energy demand. For some types of non-renewable energy sources (e.g., coal, liquid fuel, gas), the fuel source is transported to a local power plant that is conveniently located near a populated area, the fuel amount being adjusted to align with energy supply/demand. In contrast, renewable energy sources (wind, solar, hydro) are not transportable, such that power must be generated on site where the source is available, then transmitted to a populated area. As the source availability fluctuates, energy storage may be needed to act as a buffer to regulate supply/demand.

Hydrogen is seen as one option for storage and conversion of energy back to electricity at the consumption point by use of hydrogen fuel cells, but storage of hydrogen in liquid form (liquefaction) and its transport involve relatively high pressures (e.g., 700 bar). The liquefaction, storage of liquid hydrogen and transport is costly in energy consumption, and may be a safety concern.

Ammonia (NH₃) offers interesting opportunities as a hydrogen carrier, carrying three hydrogen atoms in a single ammonia molecule. Additionally, ammonia may be used as a fuel and thus as a direct source of energy with emerging technologies such as NH₃ fuel cells, combustion engines, and gas turbines for power generation. In fact, some studies are showing equivalent or higher energy efficiencies by using ammonia over liquid hydrogen.

Traditionally, ammonia is generated using the Haber-Bosch process, however the process may rely on burning methane gas to generate hydrogen, whereby the process may produce harmful emissions that may contribute to global warming. Green ammonia is produced by a new process in which the hydrogen atoms are derived from electrolysis of water, and the nitrogen is derived from the air via a separation unit, and both are powered by renewable energy sources, which may avoid harmful emissions.

However, there remains the challenge of delivering ammonia or like liquefied fuel to a point of use in an efficient manner.

### SUMMARY OF THE APPLICATION

It is therefore an aim of the present disclosure to provide a liquefaction heat pump system for a piping grid network that addresses issues related to the art.

In a first aspect, there is provided a liquefaction heat pump system comprising: a storage vessel configured to receive a liquified fuel from a piping grid network; a heat pump circuit including sequentially at least a compression stage configured to compress the fuel, a heat pump stage configured to receive the compressed fuel from the compression stage, and to heat a coolant by removing heat from the compressed fuel by at least one heat exchanger; and a pumping arrangement configured to pump fuel from the storage vessel and/or from the heat pump circuit back to the piping grid network; and a controller unit configured for operating the liquefaction heat pump system such that fuel is liquefied and a coolant is heated by the heat pump circuit.

In a second aspect, there is provided a piping grid network comprising: at least one liquefied fuel source; at least one liquefied fuel demand; and at least one liquefaction heat pump system as described above, the at least one liquefaction heat pump system between the liquefied fuel source and the liquefied fuel demand, the at least one liquefaction heat pump system operable to maintain the fuel in a liquefied state, and to generate heat to a heat demand.

In a third aspect of the present disclosure, there is provided a system, comprising: a processing unit; and a non-transitory computer-readable memory communicatively coupled to the processing unit and comprising computer-readable program instructions executable by the processing unit for: receiving and storing liquid ammonia from an ammonia piping grid network; displacing gaseous ammonia from the storing to a compression stage; generating heat by compressing the gaseous ammonia in the compression stage; heating a coolant with the compressed gaseous ammonia; liquefying the gaseous ammonia; and pumping the ammonia in a liquid state back into the ammonia piping grid network.

### BRIEF DESCRIPTION OF THE DRAWINGS

FIG. 1 is a schematic view of an ammonia piping grid network having liquefaction heat pump systems in accordance with the present disclosure;

FIG. 2 is a block diagram of a liquefaction heat pump system of the ammonia piping grid network of FIG. 1, in accordance with a first aspect;

FIG. 3 is a block diagram of a liquefaction heat pump system of the ammonia piping grid network of FIG. 1, in accordance with a second aspect;

FIG. 4 is a block diagram of a liquefaction heat pump system of the ammonia piping grid network of FIG. 1, in accordance with a third aspect; and

FIG. 5 is a block diagram of a liquefaction heat pump system of the ammonia piping grid network of FIG. 1, in accordance with a fourth aspect.

### DESCRIPTION OF THE PREFERRED EMBODIMENTS

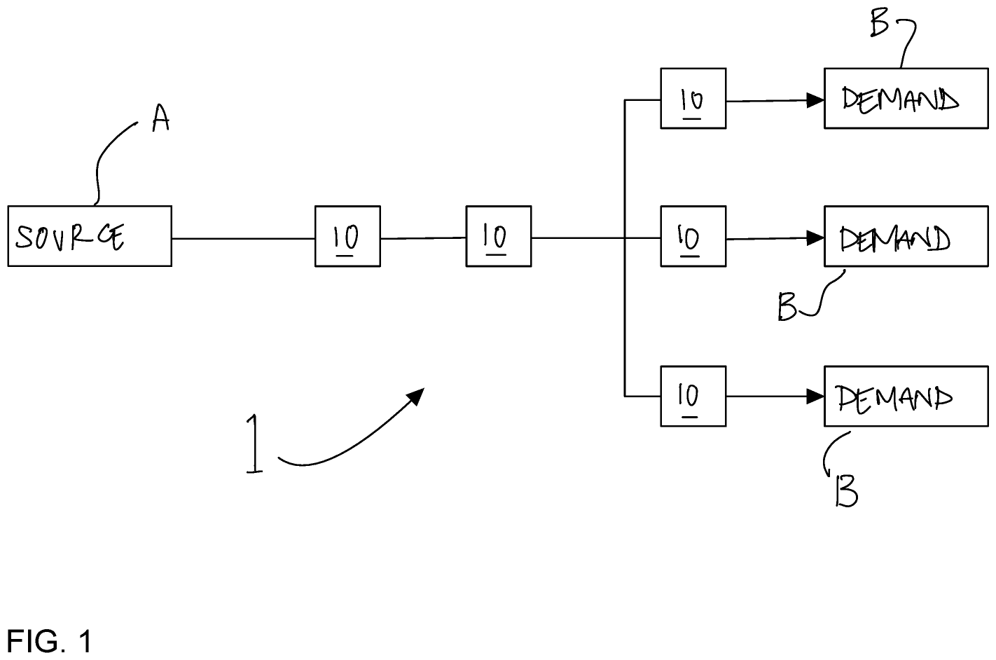

Referring to FIG. 1, an ammonia piping grid network is generally shown at 1, in a schematic manner. The ammonia piping grid network 1 is generally shown as having a source A of ammonia, such as a source of renewable energy that is used to generate ammonia, and demand(s) B, with piping relating the source A to the demands B being illustrated as lines in FIG. 1. The ammonia of the source A may include at least a proportion of green ammonia, i.e., ammonia produced by a process in which the hydrogen atoms are derived from electrolysis of water, and the nitrogen is derived from the air via a separation unit. One or both of these subprocesses may be powered by renewable energy sources to limit or avoid harmful emissions. The lines may be referred to as pipes, piping, pipeline, pipeline segments and are essentially channels through which ammonia circulates, primarily in a liquid form, though some gas form may also be present. The present disclosure focuses on ammonia, but it is considered to use the piping grid network 1 for other liquefied fuels, in spite of the fact that the piping grid network 1 is referred to herein as ammonia piping grid network 1. Even of the moniker “ammonia” is used herein, the piping grid network 1 may be used with other types of fuels.

The ammonia piping grid network 1 has one or more liquefaction heat pump systems 10, that may serve a dual purpose: to transport/store ammonia for the purpose of power generation or like uses at demand(s) B, and/or to be utilized as a heat pump to produce heat, such as in the form of hot water. Thus the ammonia piping grid network 1 may satisfy some heating demands. For example, the heat demand for the heat produced may be in the form of district heating at the liquefaction heat pump system 10. Therefore, while energy is consumed at the liquefaction heat pump systems 10 to preserve the liquefied state of ammonia and/or to remove flash gas, as a whole the presence of the liquefaction heat pump systems 10 is an efficient use of energy as heat generated at the liquefaction heat pump systems 10 is claimed for local heating demands. Hence, the heat generated at the liquefaction heat pump systems 10 may be said to be reclaimed.

As observed in FIG. 1, the liquefaction heat pump systems 10 (if more than one present) can be connected in parallel and/or in series to optimize the overall grid efficiency of the ammonia piping grid network 1, with the ammonia piping grid network 1 having some parallel liquefaction heat pump systems 10 and some liquefaction heat pump systems 10 in series. The operating parameters of the liquefaction heat pump systems 10 can be adjusted to optimize the ammonia conditions (temperature and pressure) to suit the demands B, such as a power generation process, and/or to enhance transportation conditions. The efficiency of the ammonia piping grid network 1 may rely on maintaining the ammonia mostly in liquid state, as the density of liquid is higher than vapor (a.k.a., vapour) which enables a more efficient rate of ammonia transfer and storage, and/or more efficient conversion to electrical energy at the demand(s) B. In the liquefaction heat pump system(s) 10, cooling of the ammonia is achieved, and such cooling increases the density, and this may result in higher mass/volume and in an increase ammonia in delivery content.

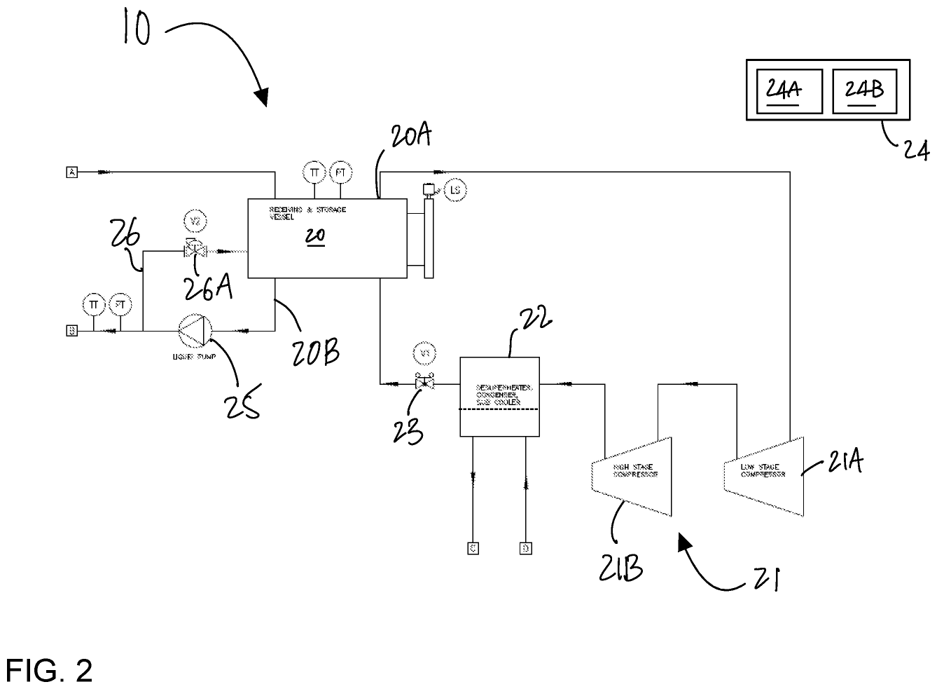

Referring to FIG. 1, the source A may be any appropriate source of ammonia, such as an ammonia production facility, an ammonia transport facility, ammonia storage, off-shore ammonia unloading facility (for ammonia received via ship), ammonia tanker unloading facility (for ammonia received via truck), as examples among others. If the liquefied fuel is not ammonia, the source A may be any of the above, but for the liquefied fuel. In FIGS. 2-5, A is illustrated, and may be any such source A, or may be an upstream liquefaction heat pump system 10. Thus, in FIGS. 2-5, item A may also represent incoming ammonia to the liquefaction heat pump system 10. The incoming ammonia may be liquid, vapor, or a two-phase liquid/vapor mixture. There may also be more than one source A, at other locations in the piping grid network 1.

Referring to FIG. 1, the demand(s) B may be any demand of ammonia, such as an ammonia power generation unit or station, that may be via ammonia fuel cells, dehydrogenation and use in a hydrogen cell, ammonia direct fired gas turbine, ammonia direct fired combustion engine, ammonia storage, off-shore ammonia loading facility (for ammonia to be transported via ship), ammonia tanker loading facility (for ammonia transported via truck), as examples among others. In FIGS. 2-5, B is illustrated, and may be any such demand B, or may be a downstream liquefaction heat pump system 10. Thus, in FIGS. 2-5, B may also represent outgoing ammonia from the liquefaction heat pump system 10. The incoming ammonia may be saturated liquid or a sub-cooled liquid.

In FIG. 1, numerous liquefaction heat pump systems 10 are shown to illustrate that serial and parallel arrangements are possible, for one source A (though more could be present), and multiple demands B (though a single one could be present). The liquefaction heat pump systems 10 of FIG. 1 may be any of those described below in FIGS. 2 to 5, i.e., the ammonia piping grid network 1 may have different types of liquefaction heat pump systems 10, or all of the liquefaction heat pump systems 10 in the piping grid network 1 may be the same. Moreover, other components may be present in the piping grid network 1, considering that the piping grid network 1 may cover hundreds or thousands of kilometers, and must therefore have joints, valves, stations, pumps, insulators, etc.

The ammonia piping grid network 1 may cover large distances, measureable in kilometers or miles, though the ammonia piping grid network 1 could be at a smaller scale as well. The ammonia piping grid network 1 employs liquefaction heat pump systems 10 to generate district NH₃ heating, the liquefaction heat pump system(s) 10 also serving as storage unit, liquefaction unit, recirculating system with a compressor used to maintain the ammonia in liquid state. While the liquefaction heat pump system(s) 10 receives the ammonia or like fuel mostly in a liquid state, the moniker “liquefaction” is used because the liquefaction heat pump system(s) 10 may be used to liquefy some ammonia or like fuel in a gaseous state, and/or may help maintain the ammonia or like fuel in the liquid state, for example by lowering the temperature and/or increasing the pressure of the ammonia or like fuel in the ammonia piping grid network 1. The liquefaction heat pump system 10 may be coupled with ammonia liquid pumps to transport the ammonia to other districts or consumption points of use (i.e., demands B).

Therefore, in a variant, the liquefaction process at the liquefaction heat pump system 10 is required because as the ammonia is pumped along large distances in the ammonia piping grid network 1, pressure drop and/or temperature rise for the ammonia may cause flash gas formation in the liquid ammonia. Flash gas formation may create an additional load that affects the efficiency of the ammonia piping grid network 1. The liquefaction heat pump system(s) 10 are facilities that may be strategically located to also supply district water heating to populated communities, or to local plants or like industrial facilities, processes, etc.

Referring to FIG. 2, a first variant of the liquefaction heat pump system 10 is illustrated. The liquefaction heat pump system 10 receives ammonia from A in a storage vessel 20. The storage vessel 20 is shown as a single unit, but other vessels 20 may be present. The storage vessel(s) 20 may be referred to as receiver, tank, reservoir, buffer, receiving and storage vessels, etc. The storage vessel(s) 20 is a vessel in which the ammonia is stored mostly in a liquid state, with vapor.

The liquefaction heat pump system 10 of FIG. 2 may include a heat pump circuit that may have a compression stage 21, a heat pump stage 22, and an expansion stage 23, as an example. Other components may be present, and each of these stages may include numerous components, devices (e.g., valves, ports, sensors, etc), apparatuses.

The compression stage 21 may include one or more compressors, in any appropriate arrangement. In a variant, the compression stage 21 has numerous compressors in parallel and/or cascaded. In the illustrated embodiment, the compressor stage 21 has cascaded compressors 21A and 21B, i.e., compressors in series. While FIG. 2 shows a single compressor 21A and a second compressor 21B, 21A and 21B may each have multiple compressors. In such a cascade arrangement, the compressor(s) 21A is a low stage compressor, and the compressor(s) 21B is a high stage compressor. In the illustrated embodiment, ammonia exits the storage vessel 20, for instance as suction vapor obtained from the top 20A of the storage vessel 20, to be fed to the low stage compressor 21A.

The ammonia enters compressor(s) 21A in the compression stage 21 as a saturated vapor (for example) and is compressed to a higher pressure and temperature. The hot ammonia vapor leaves the discharge of the low stage compressor(s) 21A and enters the suction of the high stage compressor(s) 21B. The high stage compressor(s) 21B may be tasked with compressing the ammonia to an appropriate discharge condition based on the components of the heat pump circuit downstream thereof, such as for example the heat absorption capacity of the heat pump stage 22.

The compressed ammonia vapor (e.g., superheated vapor) is then routed to heat pump stage 22. The heat pump stage 22 may have other names, such as desuperheater, condenser, cooler, reclaim stage, etc. The heat pump stage 22 is shown schematically as a single block in FIG. 2, but may have numerous components, coolers, sub-coolers, coils, heat exchangers. In a variant, the heat pump stage 22 is used to capture heat using water or other coolant or fluids, including air to be heated. Accordingly, the heat pump stage 22 is shown as having an outlet C and an inlet D, and features one or more heat exchangers for ammonia exiting the compression stage 21 to be in heat exchange with a coolant.

In such a variant, outlet C is an outgoing hot water supply (or other coolant) from the liquefaction heat pump system 10 to a hydronic water heating loop. Inlet D is the incoming cold water supply to the liquefaction heat pump system 10 from the hydronic water heating loop. The hydronic water heating loop could be supporting one end user or multiple end users such as a district heating system. The type of end user can be an industrial, commercial, and/or residential building, or multiple buildings. The outlet C may alternatively heat another coolant, such as for example a glycol solution or any other fluid common to the HVAC industry.

Thus, in the heat pump stage 22, the ammonia or like fuel is cooled and may be condensed into a liquid by flowing through one or more cooling unit(s), in which the ammonia circulates through coils with a coolant such as water flowing across the coils, whereby the circulating ammonia rejects heat from the liquefaction heat pump system 10, the rejected heat being captured and carried away by the coolant (e.g., water, glycol). In a variant, depending on the temperature and pressure of the ammonia, the heat pump stage 22 may feature numerous stages, that may be as an example regarded as desuperheating, condensing and/or sub-cooling, sequentially one after the other. The goal is to absorb heat efficiently from the ammonia. The desuperheater(s), condenser(s) and sub-cooler(s) may be one or a series of multiple ammonia-to-coolant heat exchangers, where the ammonia undergoes different stages of cooling and the heat is transferred to increase the temperature of the incoming coolant C, while reducing that of the ammonia (or reducing the pressure of the ammonia, and/or absorbing latent heat, etc). Desuperheating occurs to cool the ammonia at a constant pressure down from a superheated vapor to a saturated vapor. The condensation process occurs to change the ammonia from saturated vapor to saturated liquid. The subcooling process is performed to extract more heat from the ammonia.

The condensed liquid ammonia at the outlet of the heat pump stage 22 may next be directed through an expansion stage 23 in which a valve(s) of any type, such as expansion valves, causes a reduction in pressure and/or temperature to the ammonia, which may for example become a cooler saturated liquid. The ammonia may consequently return to the storage vessel 20, in a colder state than when it exited the storage vessel 20 in the heat pump circuit, and after being used to generate heat.

A controller unit 24 may be used to centrally control the various components and stages of the liquefaction heat pump system 10, including those of the heat pump circuit. The controller unit 24 is the processing unit of the liquefaction heat pump system 10, and may have one or more processors 24A. A non-transitory computer-readable memory 24B may be communicatively coupled to the processing unit and may have computer-readable program instructions executable by the processing unit for operating the heat pump circuit described herein.

The controller unit 24 has a processor with user interfaces, and may receive data from various sensors located at different locations in the liquefaction heat pump system 10 and in the environment of the liquefaction heat pump system 10, e.g., temperature and pressure sensors, etc. For example, the liquefaction heat pump system 10 is shown having pressure transducer PT, provided to sense the pressure of the ammonia. Temperature transducer TT monitors the temperature of the ammonia. Level sensors LS monitor the liquid level of ammonia. The controller unit 24 may also communicate with the components of the liquefaction heat pump system 10, to turn them on and off, and to adjust their operating parameters. This may include the operation of valves (e.g., solenoid valves) located throughout the liquefaction heat pump system 10. The controller unit 24 may also be in communication with user applications that can seek operator guidance remotely. For example, a user device may be in wireless communication with the controller unit 24, for instance by cellular network and/or internet, etc. The controller unit 24 receives operational data from various sensors in the liquefaction heat pump system 10, or associated with the liquefaction heat pump system 10, and may operate the heat pump circuit as a function of the sensor data. For example, via the readings of the sensors in the storage vessel 20, the compressor(s) of the compression stage 21 may be turned on for the heat pump circuit to be operated. The operation of the heat pump circuit may for example be intermittent, or continuous. The individual controller unit 24 of one liquefaction heat pump system 10 may communicate with one or more, e.g., all other controller units 24 of other liquefaction heat pump systems 10 such that all systems 10 that form the grid 1 in FIG. 1 may communicate together on a single network. This would enable a centralized controller or operator to have full control of the system. A centralized controller can optimize overall grid performance based on source A conditions and demand B conditions. The operating program for controller units 24 may be stored at the local unit or may be cloud-based, for example.

The liquefaction heat pump system 10 may further include a pump(s) 25 or like pumping device(s) or pumping arrangement. In an embodiment, the pump 25 may be a mechanical liquid ammonia pump that pumps liquid ammonia out of the storage vessel 20. For example, the pump 25 may be connected to a bottom of the storage vessel 20, as shown as 20B, by a pipe in the lower half of the storage vessel 20. As an option, a bypass 26 is provided, the bypass having regulator valve 26A. The bypass 26 is used to allow the pump 25 to operate at a constant flow rate, as the bypass 26 may compensate for any flow rate fluctuation downstream of the storage vessel 20 in the ammonia piping grid network 1. The level switch LS and/or downstream monitoring of the pump discharge pressure ensure there is sufficient liquid for the pump(s) 25 to operate. The cooling process of the ammonia ensures there is enough liquid in the storage vessel 20 and may also serve to ensure there is sufficient liquid to maintain a minimum net pressure suction available to ensure there is no cavitation inside the pump(s) 25.

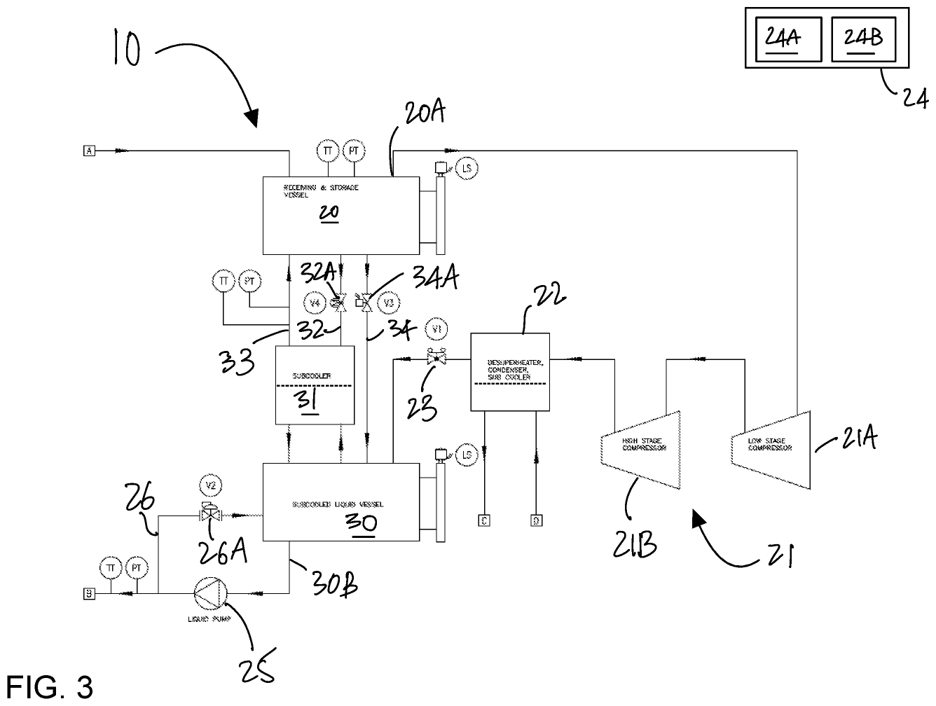

Referring to FIG. 3, a second variant of the liquefaction heat pump system 10 is illustrated. The second variant in FIG. 3 bears some similarities with the first variant of the liquefaction heat pump system 10 of FIG. 2, whereby like elements will bear like reference numerals. In the second variant of FIG. 3, sub-cooled liquid ammonia can travel further along the pipeline of the ammonia piping grid network 1 before vaporizing.

The liquefaction heat pump system 10 receives ammonia from A in a storage vessel 20. The storage vessel 20 is shown as a single unit, but other vessels 20 may be present. The storage vessel(s) 20 may be referred to as receiver, tank, reservoir, in which the ammonia is stored mostly in a liquid state, with vapor.

In similar fashion to the variant of FIG. 2, the liquefaction heat pump system 10 of FIG. 3 may include a heat pump circuit that may have a compression stage 21, a heat pump stage 22, an expansion stage 23, and a subcooled liquid vessel 30, as an example. Other components may be present, and each of these stages may include numerous components, devices, apparatuses.

The compression stage 21 may include one or more compressors, in any appropriate arrangement. In a variant, the compression stage 21 has numerous compressors in parallel and/or cascaded. In the illustrated embodiment, the compressor stage 21 has cascaded compressors 21A and 21B, i.e., compressors in series. While FIG. 3 shows a single compressor 21A and a second compressor 21B, 21A and 21B may each have multiple compressors. In such a cascade arrangement, the compressor(s) 21A is a low stage compressor, and the compressor(s) 21B is the high stage compressor. In the illustrated embodiment, ammonia exits the storage vessel 20, for instance as suction vapor obtained from the top 20A of the storage vessel 20, to be fed to the low stage compressor 21A.

The ammonia enters compressor(s) 21A in the compression stage 21 as a saturated vapor and is compressed to a higher pressure and temperature. The hot ammonia vapor leaves the discharge of the low stage compressor(s) 21A and enters the suction of the high stage compressor(s) 21B.

The compressed ammonia vapor (e.g., superheated vapor) is then routed to heat pump stage 22. The heat pump stage 22 may have other names, such as desuperheater, condenser, cooler, reclaim stage, etc. The heat pump stage 22 is shown schematically as a single block in FIG. 3, but may have numerous components, coolers, sub-coolers, coils, heat exchangers. In a variant, the heat pump stage 22 is used to capture heat in the form of water or other coolant. Accordingly, the heat pump stage 22 is shown as having an outlet C and an inlet D, and features one or more heat exchangers for ammonia to be in heat exchange with a coolant.

In such a variant, outlet C is outgoing hot water supply from the liquefaction heat pump system 10 to a hydronic water heating loop. Inlet D is the incoming cold water supply to the liquefaction heat pump system 10 from the hydronic water heating loop. The hydronic water heating loop could be supporting one end user or multiple end users such as a district heating system. The type of end user can be an industrial, commercial, and/or residential building. The outlet C may alternatively heat another coolant, such as for example a glycol solution or any other fluid common to the HVAC industry.

Thus, in the heat pump stage 22, the ammonia is cooled and may be condensed into a liquid by flowing through one or more cooling unit(s), in which the ammonia circulates through coils with a coolant such as water flowing across the coils, whereby the circulating ammonia rejects heat from the liquefaction heat pump system 10, the rejected heat being reclaimed and carried away by the coolant (e.g., water, glycol). In a variant, depending on the temperature and pressure of the ammonia, the heat pump stage 22 may feature numerous stages, that may be as an example regarded as desuperheating, condensing and/or sub-cooling, sequentially one after the other. The goal is to absorb heat efficiently from the ammonia. The desuperheater(s), condenser(s) and sub-cooler(s) may be one or a series of multiple ammonia-to-coolant heat exchangers, where the ammonia undergoes different stages of cooling and the heat is transferred to increase the temperature of the incoming coolant C. Desuperheating occurs to cool the ammonia at a constant pressure down from a superheated vapor to a saturated vapor. The condensation process occurs to change the ammonia from saturated vapor to saturated liquid. The subcooling process is performed to extract more heat from the ammonia.

The condensed liquid ammonia at the outlet of the heat pump stage 22 may next be directed through an expansion stage 23 in which valve(s) of any type, such as expansion valves, causes a reduction in pressure and/or temperature to the ammonia, which may for example become a cooler saturated liquid.

The ammonia may then be directed to the subcooled liquid vessel 30, in a colder state than when it exited the storage vessel 20 in the heat pump circuit.

Subcooler heat exchanger(s) 31 is connected to and operates on a thermosyphon principle between the storage vessel 20 and the subcooled liquid vessel 30. Control valve 32A is in a line 32 used to selectively feed liquid ammonia from the storage vessel 20 to the subcooler heat exchanger 31. In the subcooler heat exchanger 31, the liquid ammonia is evaporated and returned to the storage vessel 20 as vapor. The control valve 32A is controlled based on the temperature and pressure (a.k.a., superheat) of the return vapor in line 33, as observed via the sensors (and with check valves optionally present). In parallel, liquid ammonia from the subcooled liquid vessel 30 enters the subcooler heat exchanger 31 and is subcooled at a constant pressure.

Again, the controller unit 24 may be used to centrally control the various components and stages of the liquefaction heat pump system 10, including those of the heat pump circuit.

The liquefaction heat pump system 10 of FIG. 3 may further include a pump(s) 25 or like pumping device(s) as part of a pumping arrangement. In an embodiment, the pump 25 may be a mechanical liquid ammonia pump that pumps liquid ammonia out of the subcooled liquid vessel 30. For example, the pump 25 may be connected to a bottom of the subcooled liquid vessel 30, as shown as 30B in which a pipe is connected to a lower-half of the subcooled liquid vessel 30. As an option, a bypass 26 is provided, the bypass having regulator valve 26A. The bypass 26 is used to allow the pump 25 to operate at a constant flow rate, as the bypass 26 may compensate for any flow rate fluctuation downstream of the subcooled liquid vessel 30 in the ammonia piping grid network 1. The level switch LS and downstream monitoring of the pump discharge pressure ensures there is sufficient liquid for the pump(s) 25 to operate. The cooling process of the ammonia ensures there is enough liquid in the storage vessel 20 and may also serve to ensure there is sufficient liquid to maintain a minimum net pressure suction available to ensure there is no cavitation inside the pump(s) 25.

In the second variant, excess liquid ammonia build up in the storage vessel 20 can be selectively transferred directly to the subcooled liquid vessel 30 via bypass valve 34A in line 34. It may thus be said that the variant of the liquefaction heat pump system 10 of FIG. 3 has the vessels 20 and 30 isolated from one another, and in series, with the option of directing ammonia from the vessel 20 to the vessel 30.

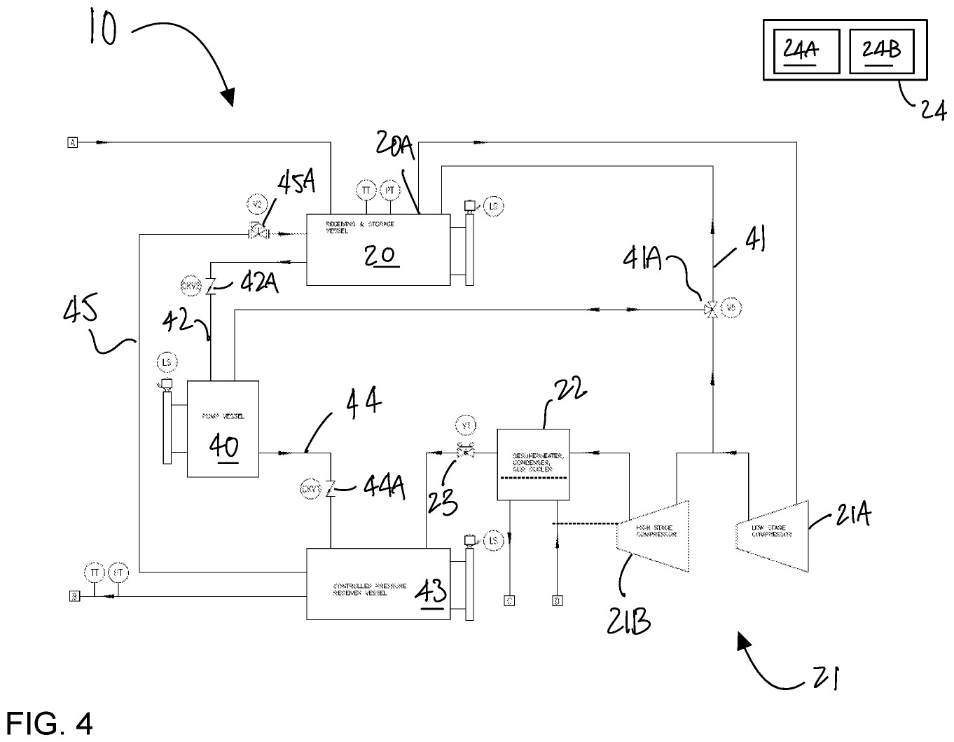

Referring to FIG. 4, a third variant of the liquefaction heat pump system 10 is illustrated. The third variant in FIG. 4 bears some similarities with the first variant of the liquefaction heat pump system 10 of FIG. 2 and the second variant of the liquefaction heat pump system 10 of FIG. 3, whereby like elements will bear like reference numerals. In the third variant of FIG. 4, in the pumping arrangement, hot gas pumping is used instead of the mechanical pumps 25 of FIGS. 2 and 3. Generally speaking, mechanical pumping is a more efficient pumping arrangement in terms of energy usage than hot gas pumping, but hot gas pumping does not rely on the use of mechanical pumps. This may reduce the maintenance required and the probability of ammonia leaks.

The liquefaction heat pump system 10 of FIG. 4 receives ammonia from A in the storage vessel 20. The storage vessel 20 is shown as a single unit, but other vessels 20 may be present. The storage vessel(s) 20 may be referred to as receiver, tank, reservoir, in which the ammonia is stored mostly in a liquid state, with vapor.

The liquefaction heat pump system 10 of FIG. 4 may further include a pump vessel 40, that may contribute to the umping. The pump vessel 40 is shown as a single unit, but other vessels 40 may be present as part of the pump vessel system. The pump vessel(s) 40 may also be referred to as receiver, tank, reservoir.

A valve assembly 41A is in a line network 41 enabling a fluid communication between the storage vessel 20, the compression stage 21 and the pump vessel 40, the fluid communication being selectively opened and closed as described below. The valve assembly 41A may be any appropriate arrangement of valve(s) enabling the fluid communications described below. For example, the valve assembly 41A may be a three-way valve. The valve assembly 41A is actuated to open a fluid communication between the storage vessel(s) 20 and the pump vessel(s) 40, allowing them to equalize pressure. As a result of pressure equalizing, a drainage of liquid ammonia from the storage vessel(s) 20 to the pump vessel(s) 40 through line 42 may occur. Line 42 may have a check valve 42A or any appropriate valve arrangement to allow the unidirectional liquid flow from the storage vessel(s) 20 to the pump vessel(s) 40.

The liquefaction heat pump system 10 of FIG. 4 may also include a heat pump circuit that may have a compression stage 21, a heat pump stage 22, an expansion stage 23, and a controlled pressure receiver vessel 43 as an example. Other components may be present, and each of these stages may include numerous components, devices, apparatuses.

The compression stage 21 may include one or more compressors, in any appropriate arrangement. In a variant, the compression stage 21 has numerous compressors in parallel and/or cascaded. In the illustrated embodiment, the compressor stage 21 has cascaded compressors 21A and 21B, i.e., compressors in series. While FIG. 2 shows a single compressor 21A and a second compressor 21B, 21A and 21B may each have multiple compressors. In such a cascade arrangement, the compressor(s) 21A is a low stage compressor, and the compressor(s) 21B is the high stage compressor. In the illustrated embodiment, ammonia exits the storage vessel 20, for instance as suction vapor obtained from the top 20A of the storage vessel 20, to be fed to the low stage compressor 21A.

The ammonia enters compressor(s) 21A in the compression stage 21 as a saturated vapor and is compressed to a higher pressure and temperature. The hot ammonia vapor leaves the discharge of the low stage compressor(s) 21A and enters the suction of the high stage compressor(s) 21B.

The compressed ammonia vapor (e.g., superheated vapor) is then routed to heat pump stage 22. The heat pump stage 22 may have other names, such as desuperheater, condenser, cooler, reclaim stage, etc. The heat pump stage 22 is shown schematically as a single block in FIG. 2, but may have numerous components, coolers, sub-coolers, coils, heat exchangers. In a variant, the heat pump stage 22 is used to capture heat in the form of water or other coolant. Accordingly, the heat pump stage 22 is shown as having an outlet C and an inlet D, and features one or more heat exchangers for ammonia to be in heat exchange with a coolant.

In such a variant, outlet C is outgoing hot water supply from the liquefaction heat pump system 10 to a hydronic water heating loop. Inlet D is the incoming cold water supply to the liquefaction heat pump system 10 from the hydronic water heating loop. The hydronic water heating loop could be supporting one end user or multiple end users such as a district heating system. The type of end user can be an industrial, commercial, and/or residential building. The outlet C may alternatively heat another coolant, such as for example a glycol solution or any other fluid common to the HVAC industry.

Thus, in the heat pump stage 22, the ammonia is cooled and may be condensed into a liquid by flowing through one or more cooling unit(s), in which the ammonia circulates through coils with a coolant such as water flowing across the coils, whereby the circulating ammonia rejects heat from the liquefaction heat pump system 10, the rejected heat being reclaimed and carried away by the coolant (e.g., water, glycol). In a variant, depending on the temperature and pressure of the ammonia, the heat pump stage 22 may feature numerous stages, that may be as an example regarded as desuperheating, condensing and/or sub-cooling, sequentially one after the other. The goal is to absorb heat efficiently from the ammonia. The desuperheater(s), condenser(s) and sub-cooler(s) may be one or a series of multiple ammonia-to-coolant heat exchangers, where the ammonia undergoes different stages of cooling and the heat is transferred to increase the temperature of the incoming coolant C. Desuperheating occurs to cool the ammonia at a constant pressure down from a superheated vapor to a saturated vapor. The condensation process occurs to change the ammonia from saturated vapor to saturated liquid. The subcooling process is performed to extract more heat from the ammonia.

The condensed liquid ammonia at the outlet of the heat pump stage 22 may next be directed through an expansion stage 23 in which valve(s) of any type, such as expansion valves, causes a reduction in pressure and/or temperature to the ammonia, which may for example become a cooler saturated liquid. The ammonia may then be directed to the controlled pressure receiver vessel 43, in a colder state than when it exited the storage vessel 20 in the heat pump circuit.

Again, the controller unit 24 may be used to centrally control the various components and stages of the liquefaction heat pump system 10, including those of the heat pump circuit.

In the variant of FIG. 4, the ammonia exits the liquefaction heat pump system 10 via the controlled pressure receiver vessel 43. As set out above, the pump vessel 40 accumulates liquid from the storage vessel 20 via pressure balancing. The pump vessel 40 and the controlled pressure receiver vessel 43 may have a fluid communication between them, via line 44 having a valve 44A. For example, the valve 44A may be a check valve, though other types of valves may be used with similar functionality. As pressure in the pump vessel 40 is lower than the pressure in the controlled pressure receiver vessel 43 at this stage, the valve 44A blocks any high pressure ammonia in the controller pressure receiver 43 from flowing into the pump vessel 40. Once level sensor LS on the pump vessel 40 reaches a given liquid level threshold, the valve assembly 41A switches position and opens flow from the compression stage 21 (e.g., discharge line of the low stage compressor 21A) to the pump vessel 40. This may occur for example by control commands of the controller unit 24. This causes ammonia vapor from the compression stage 21 (e.g., lower stage of compression 21A) to push the liquid ammonia of the pump vessel 40. As a result, the pressure of the pump vessel 40 exceeds that in the controlled pressure receiver vessel 43, which causes the high pressure ammonia in the pump vessel 40 to travel through the line 44 having opened check valve 44A, and push the liquid ammonia out of the controller pressure receiver vessel 43 toward B.

Still in the variant of FIG. 4, a line 45 featuring regulator valve 45A defines a bypass between the storage vessel 20 and the controlled pressure receiver vessel 43. During the pumping stage, when liquid ammonia is being pushed out of controlled pressure receiver vessel 43, any residual vapour in 43 would vent back through valve 45A to storage vessel 20.

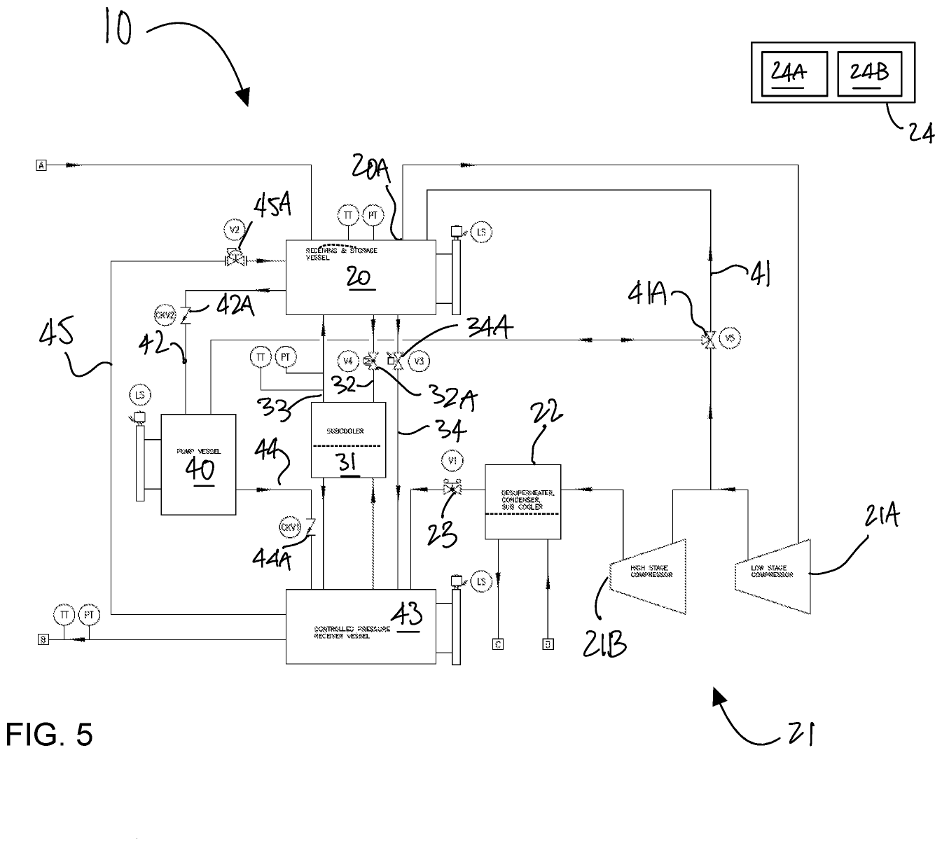

Referring to FIG. 5, a fourth variant of the liquefaction heat pump system 10 is illustrated. The fourth variant in FIG. 5 bears some similarities with the first variant of the liquefaction heat pump system 10 of FIG. 4, whereby like elements will bear like reference numerals. In the fourth variant of FIG. 5, hot gas pumping as in FIG. 4 is used instead of the mechanical pumps 25 of FIGS. 2 and 3, and sub-cooled liquid ammonia can travel further along the pipeline of the ammonia piping grid network 1 before vaporizing.

In particular, ammonia exiting the heat pump stage 22 may be directed to the controlled pressure receiver vessel 43, in a colder state than when it exited the storage vessel 20 in the heat pump circuit.

Subcooler heat exchanger(s) 31 is connected to and operates on a thermosyphon principle between the storage vessel 20 and the controlled pressure receiver vessel 43. Control valve 32A is in a line 32 used to selectively feed liquid ammonia from the storage vessel 20 through the subcooler heat exchanger 31. In the subcooler heat exchanger 31, the liquid ammonia is evaporated and returned to the storage vessel 20 as vapor. The control valve 32A is controlled based on the temperature and pressure (a.k.a., superheat) of the return vapor in line 33, as observed via the sensors (and with check valves optionally present). In parallel, liquid ammonia from the controlled pressure receiver vessel 43 enters the subcooler heat exchanger 31 and is subcooled at a constant pressure.

Excess liquid ammonia build up in the storage vessel 20 can be selectively transferred directly to the controlled pressure receiver vessel 43 via bypass valve 34A in line 34.

In similar fashion to the variant of FIG. 4, the ammonia exits the liquefaction heat pump system 10 via the controlled pressure receiver vessel 43. As set out above, the pump vessel 40 accumulates liquid from the storage vessel 20 via pressure balancing. The pump vessel 40 and the controlled pressure receiver vessel 43 may have a fluid communication between them, via line 44 having a valve 44A. For example, the valve 44A may be a check valve, though other types of valves may be used with similar functionality. As pressure in the pump vessel 40 is lower than the pressure in the controlled pressure receiver vessel 43 at this stage, the valve 44A blocks any high pressure ammonia in the controller pressure receiver 43 from flowing into the pump vessel 40. Once level sensor LS on the pump vessel 40 reaches a given liquid level threshold, the valve assembly 41A switches position and opens flow from the compression stage 21 (e.g., discharge line of the low stage compressor 21A) to the pump vessel 40. This may occur for example by control commands of the controller unit 24. This causes ammonia vapor from the compression stage 21 (e.g., lower stage of compression 21A) to push the liquid ammonia of the pump vessel 40. As a result, the pressure of the pump vessel 40 exceeds that in the controlled pressure receiver vessel 43, which causes the high pressure ammonia in the pump vessel 40 to travel through the line 44 having opened check valve 44A, and push the liquid ammonia out of the controller pressure receiver vessel 43 toward B.

In the variant of FIG. 5, the line 45 featuring regulator valve 45A defines a bypass between the storage vessel 20 and the controlled pressure receiver vessel 43. During the pumping stage, when liquid ammonia is being pushed out of controlled pressure receiver vessel 43, any residual vapour in 43 would vent back through valve 45A to storage vessel 20.

To summarize, in a variant, the liquefaction heat pump system 10 may be described as having a storage vessel configured to receive a liquified fuel from a piping grid network; a heat pump circuit including sequentially at least a compression stage configured to compress the fuel, a heat pump stage configured to receive the compressed fuel from the compression stage, and to heat a coolant by removing heat from the compressed fuel by at least one heat exchanger; and a pumping arrangement configured to pump fuel from the storage vessel and/or from the heat pump circuit back to the piping grid network. A controller unit is configured for operating the liquefaction heat pump system such that fuel is liquefied and a coolant is heated by the heat pump circuit. A piping grid network 1 may include at least one liquefied fuel source; at least one liquefied fuel demand; and at least one liquefaction heat pump system as described herein with reference to FIGS. 2 to 5, the at least one liquefaction heat pump system between the liquefied fuel source and the liquefied fuel demand, the at least one liquefaction heat pump system operable to maintain the fuel in a liquefied state, and to generate heat to a heat demand.

The present disclosure also pertains to a system that may have a processing unit; and a non-transitory computer-readable memory communicatively coupled to the processing unit and comprising computer-readable program instructions executable by the processing unit for: receiving and storing liquid ammonia from an ammonia piping grid network; displacing gaseous ammonia from the storing to a compression stage; generating heat by compressing the gaseous ammonia in the compression stage; heating a coolant with the compressed gaseous ammonia; liquefying the gaseous ammonia; and pumping the ammonia in a liquid state back into the ammonia piping grid network.

1. A liquefaction heat pump system comprising:
a storage vessel configured to receive a liquified fuel from a piping grid network;
a heat pump circuit including sequentially at least
a compression stage configured to compress the fuel,
a heat pump stage configured to receive the compressed fuel from the compression stage, and to heat a coolant by removing heat from the compressed fuel by at least one heat exchanger; and
a pumping arrangement configured to pump fuel from the storage vessel and/or from the heat pump circuit back to the piping grid network; and
a controller unit configured for operating the liquefaction heat pump system such that fuel is liquefied and a coolant is heated by the heat pump circuit.

2. The liquefaction heat pump system according to claim 1, wherein the compressor stage includes a plurality of compressors.

3. The liquefaction heat pump system according to claim 2, wherein the compressor stage includes compressors in a cascaded arrangement.

4. The liquefaction heat pump system according to claim 1, wherein the heat pump stage includes one or more of a desuperheater, a condenser and/or a sub-cooler.

5. The liquefaction heat pump system according to claim 1, wherein the coolant is water.

6. The liquefaction heat pump system according to claim 1, wherein the at least one heat exchanger of the heat pump stage is in fluid communication with a district heating network for the coolant to be used in district heating.

7. The liquefaction heat pump system according to claim 1, including a second vessel downstream of the heat pump stage to receive the fuel from the heat pump stage.

8. The liquefaction heat pump system according to claim 7, further including a subcooling heat exchange circuit between the storage vessel and the second vessel to remove heat from the fuel in the second vessel.

9. The liquefaction heat pump system according to claim 7, wherein the pumping arrangement includes a pump vessel in selective fluid communication with the storage vessel and the second vessel, a line extending from the compressor stage to the pump vessel, the line being selectively opened by the controller unit to control a pressure in the pump vessel and to cause a pressure increase in the pump vessel to pump the fuel out of the second vessel into the piping grid network.

10. The liquefaction heat pump system according to claim 1, wherein the pumping arrangement includes a pump downstream of the heat pump circuit to pump the fuel back into the piping grid network.

11. The liquefaction heat pump system according to claim 10, including a bypass downstream of the pump and returning fuel to the storage vessel or the heat pump circuit, the bypass including a valve operated to allow the pump to operate at a constant flow rate.

12. The liquefaction heat pump system according to claim 10, wherein the pump is a mechanical pump.

13. The liquefaction heat pump system according to claim 1, wherein the fuel is ammonia.

14. A piping grid network comprising:
at least one liquefied fuel source;
at least one liquefied fuel demand; and
at least one liquefaction heat pump system according to claim 1, the at least one liquefaction heat pump system between the liquefied fuel source and the liquefied fuel demand, the at least one liquefaction heat pump system operable to maintain the fuel in a liquefied state, and to generate heat to a heat demand.

15. The piping grid network according to claim 14, wherein the heat demand is district heating.

16. The piping grid network according to claim 14, wherein the liquefied fuel is ammonia.

17. The piping grid network according to claim 14, including a plurality of the at least one liquefaction heat pump system, at least two of the liquefaction heat pump systems being in series.

18. The piping grid network according to claim 14, including a plurality of the at least one liquefaction heat pump system, at least two of the liquefaction heat pump systems being in parallel.

19. A system comprising:
a processing unit; and
a non-transitory computer-readable memory communicatively coupled to the processing unit and comprising computer-readable program instructions executable by the processing unit for:
receiving and storing liquid ammonia from an ammonia piping grid network;
displacing gaseous ammonia from the storing to a compression stage;
generating heat by compressing the gaseous ammonia in the compression stage;
heating a coolant with the compressed gaseous ammonia;
liquefying the gaseous ammonia; and
pumping the ammonia in a liquid state back into the ammonia piping grid network.

20. The system according to claim 19, further including subcooling the ammonia in a liquid state with the stored liquid ammonia.
